(19) United States
(12) Patent Application Publication
(10) Pub. No.: US 2011/0293497 A1
(43) Pub. Date: Dec. 1, 2011

(54) METHOD OF ENRICHING A GASEOUS EFFLUENT IN ACID GAS

(75) Inventors: Alexandre Scondo, Rueil Malmaison (FR); Anne Sinquin, Bezons (FR)

(73) Assignee: IFP Energies nouvelles

(21) Appl. No.: 13/111,204

(22) Filed: May 19, 2011

(30) Foreign Application Priority Data
May 27, 2010 (FR) 10/02221

(51) Int. Cl. B01D 53/62; C09K 3/00

(52) U.S. Cl. 423/226; 252/184

(57) ABSTRACT

The present invention relates to a method of enriching a gaseous effluent in acid compounds, which comprises the following stages:
feeding into a contactor a feed gas comprising acid compounds and a composition comprising at least two liquid phases non-miscible with one another, including an aqueous phase, at least one amphiphilic compound and at least one mixture of promoters,
establishing in said contactor predetermined pressure and temperature conditions for the formation of hydrates consisting of water, promoters and acid compounds,
carrying the hydrates dispersed in the phase non-miscible in the aqueous phase through pumping to a hydrate dissociation drum,
establishing in the drum the hydrate dissociation conditions,
discharging the gas resulting from the dissociation enriched in acid compounds in relation to the feed gas.

### FIELD OF THE INVENTION

The present invention relates to the sphere of separation of acid compounds such as the hydrogen sulfide (H₂S) or the carbon dioxide (CO₂) contained in a gas stream, for example natural gas, syngas, fumes or any other industrial effluent. The present invention aims to use a composition comprising a mixture of two liquid phases non-miscible with one another, including an aqueous phase, and a mixture of promoters in a method of separating acid compounds contained in a gaseous effluent so as to increase the efficiency of this method. The invention can be applied to capture the CO₂ contained in combustion fumes.

### BACKGROUND OF THE INVENTION

Gas hydrates are solid crystals that form when gas molecules are in the presence of water under certain pressure and temperature conditions. The water molecules form dodecahedral cages that trap gas molecules such as CO₂, H₂S, methane, ethane, allowing large amounts of gas to be stored. In general, gas hydrates form naturally at low temperature and at high pressure, of the order of 16 bars at 0° C. for a gas containing 100% CO₂ and of 72 bars at 0° C. for a gas containing 16% CO₂.

Document WO-2008/142,262 describes a method of enriching a gaseous effluent in acid gas, wherein said gaseous effluent is contacted with a mixture of at least two liquid phases non-miscible with one another, including an aqueous phase, for forming hydrates. The hydrates are then carried in the non-water miscible phase to a dissociation drum where they are dissociated. The gas resulting from the dissociation stage is enriched in acid compounds in relation to the feed gas. This method is poorly suited for an industrial use because its energy consumption is high. In fact, the gaseous effluent has to be compressed to a pressure of at least 50 bars to be able to form gas hydrates. Such an energy consumption involves a considerable operating cost for acid gas capture. For an industrial application, the amounts of gas to be treated are extremely high and any improvement in the gas hydrate formation conditions (velocity, pressure, temperatures, etc.) will allow the size of the facilities and the cost of the method to be decreased.

Thus, there is a need for a method of enriching in acid compounds a gas feed from hydrate formation, a method that is both simple and efficient, and allowing large amounts of gas feeds to be treated without significantly increasing the production costs.

Surprisingly, the applicant has found that a composition comprising at least a mixture of two liquid phases non-miscible with one another, at least one of them consisting of water, at least one amphiphilic compound and at least one mixture of promoters allows the hydrate formation efficiency to be increased.

More particularly, the goal of the invention is to provide a method of enriching a gaseous effluent in acid gas, a method with a higher efficiency and allowing the economic cost of the method to be decreased. The dimensions of the facility implementing the method according to the invention are reduced.

### SUMMARY OF THE INVENTION

The object of the invention thus is a method of enriching a gaseous effluent in acid compounds, which comprises the following stages:

feeding into a contactor a feed gas comprising acid compounds and a composition comprising:
at least one mixture of two liquid phases non-miscible with one another, including an aqueous phase,
at least one amphiphilic compound,
at least one mixture of promoters comprising tetrahydrofurane and at least one promoter of formula (I)

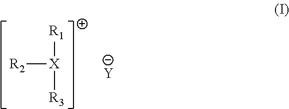

with X═S, N—R₄ or P—R₄,
Y is an anion selected from the group consisting of a hydroxyl, a sulfate or a halogen,
R₁, R₂, R₃, R₄ are identical or different, and selected from the group consisting of linear or branched C1-C5 alkyl radicals,

establishing in said contactor predetermined pressure and temperature conditions for the formation of hydrates consisting of water, promoters and said acid compounds,

carrying said hydrates dispersed in the phase non-miscible in the aqueous phase of said composition through pumping to a hydrate dissociation drum,

establishing in said drum the hydrate dissociation conditions,

discharging the gas resulting from the dissociation, said gas being enriched in acid compounds in relation to the feed gas.

Another particularly important object of the invention is a composition comprising:
at least one mixture of two liquid phases non-miscible with one another, including an aqueous phase,
at least one amphiphilic compound,
at least one mixture of promoters comprising tetrahydrofurane and at least one promoter of formula (I)

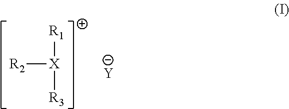

with X═S, N—R₄ or P—R₄,
Y is an anion selected from the group consisting of a hydroxyl, a sulfate or a halogen,
R₁, R₂, R₃, R₄ are identical or different, and selected from the group consisting of linear or branched C1-C5 alkyl radicals.

Another object of the invention is the use of this composition for gas hydrate formation and/or transport.

### BRIEF DESCRIPTION OF THE FIGURES

Other features and advantages of the invention will be clear from reading the description hereafter, given by way of non limitative example, with reference to the accompanying figures wherein:

FIG. 1 diagrammatically shows the method according to the invention,

FIG. 2 shows the device for studying the hydrate formation reaction kinetics,

FIG. 3 illustrates the temperature (dotted curve) and pressure (full line) variations of the gas in contact with a composition to be tested during the study of the hydrate formation reaction kinetics,

FIG. 4 shows the time constants (in hours, ordinate) of the hydrate formation reaction as a function of the initial pressure (in bars, abscissa) for various compositions tested.

### DETAILED DESCRIPTION

The present invention notably affords the advantage of:
allowing capture of acid compounds such as CO₂ and/or H₂S through gas hydrate formation at a lower pressure than that which is required for hydrate formation in a method using a composition without a promoter or with a single promoter,

allowing capture of acid compounds such as CO₂ and/or H₂S through gas hydrate formation at a higher velocity than that which is observed in a method using a composition without a promoter or with a single promoter,

capturing preferably acid compounds such as CO₂ and/or H₂S.

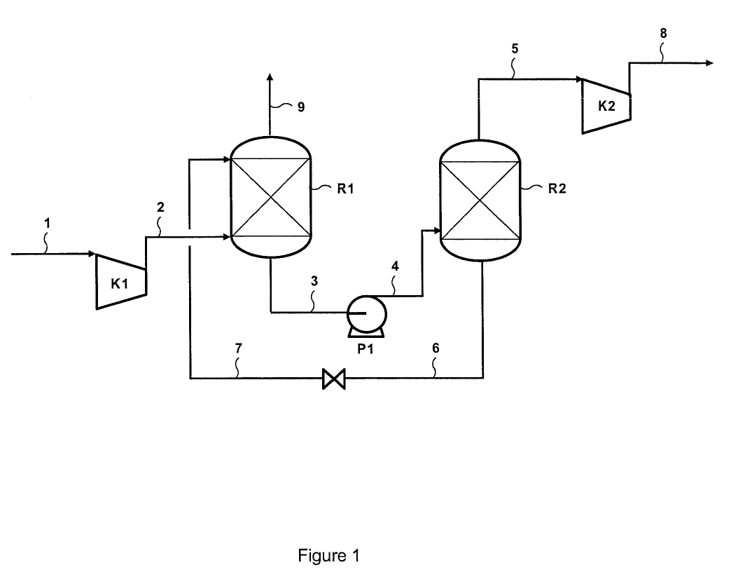

The method of enriching a gaseous effluent in acid gas according to the present invention comprises three main stages illustrated by FIG. 1:

(1) a first treating stage for contacting the feed gas containing acid compounds with a composition comprising at least one mixture of at least two liquid phases non-miscible with one another, at least one of which consists of water, at least one amphiphilic compound and at least one mixture of promoters according to the invention. The feed gas and the composition are contacted under pressure and temperature conditions compatible with the formation of a hydrate phase made up of acid compounds, water and promoters. By way of non limitative example, the hydrate formation pressure and temperature respectively range between 3 and 30 bars, and between 0° C. and 30° C. Surprisingly, the applicant has noted that combining at least two specific promoters in a mixture of two liquid phases non-miscible with one another, at least one of them consisting of water, allows gas hydrate formation at a lower pressure than without a promoter and at a higher gas capture velocity than when using a composition without a promoter or in the presence of a single promoter.

This first stage allows sequestration of a large proportion of acid gas in the hydrate phase, the gas capture velocity during hydrate formation being increased in relation to methods of the prior art. This velocity is an important criterion because it defines the contact time between the gas and the liquid composition. The higher this velocity, the higher the efficiency of the method or the smaller the size of the facility implementing the method. The gas hydrate particles thus enriched in acid compounds are dispersed in the non-water-miscible liquid and transported in form of a suspension of solids. The gas that is not converted to hydrate is thus depleted in acid compounds. If it does still not meet the required specifications, it can be subjected to a second stage of depletion by the hydrates, or it can optionally be treated by means of another gas deacidizing method. In FIG. 1, hydrate formation occurs in contactor R1 into which the feed gas flows through line 2, after compression of the incoming gas through line 1 by means of compressor K1. Line 7 supplies contactor R1 with the composition comprising at least one mixture of two liquid phases non-miscible with one another, one at least consisting of water, at least one amphiphilic compound and at least one mixture of promoters. The acid compound depleted gas is discharged through line 9 while the hydrate slurry leaves the bottom of the contactor through line 3.

(2) a second treating stage intended to increase the acid gas partial pressure of the effluent from the previous stage. It consists in pumping (P1) the suspension of solids comprising notably the hydrate phase at a pressure 2 to 200 times higher, preferably at a pressure 2 to 100 times higher, than the pressure of the feed gas and in sending it under pressure through line 4 to dissociation drum R2. In this drum, the suspension is heated so as to dissociate the hydrate particles enriched in acid gas into a mixture of two initial non-miscible liquids containing at least one amphiphilic compound and a mixture of promoters, and into a gas phase enriched in acid compounds at high pressure. The gas stream thus obtained has an acid gas content and partial pressure that is two to a hundred times higher than that of the feed gas. The gas enriched in acid compounds is discharged through line 5 and optionally compressed by compressor K2 so as to be injected for example into an underground reservoir through line 8.

(3) the mixture of liquids from stage (2), predominantly comprising the two non-miscible liquids, the amphiphilic compound(s) and the mixture of promoters is expanded/cooled so as to be sent back through lines 6 and 7 to contactor R1 of stage

The hydrate formation/dissociation process intended to deplete a feed gas for example in CO₂, then to enrich in CO₂ an effluent from the process, is carried out in a composition comprising a mixture of water-hydrate component—and of a non-water-miscible solvent. At least one mixture of two promoters and at least one amphiphilic compound having the property of stabilizing the water/non-water-miscible solvent mixture, optionally in emulsion form, are added to this mixture.

The solvent used for the method can be selected from among several families: hydrocarbon-containing solvents, silicone type solvents, halogenated or perhalogenated solvents.

In the case of hydrocarbon-containing solvents, the solvent can be selected from the group consisting of:

aliphatic cuts, for example isoparaffinic cuts having a sufficiently high flash point to be compatible with the method according to the invention,

organic solvents of aromatic cut or naphthenic cut type can also be used with the same flash point conditions,

pure products or mixtures selected from among the branched alkanes, cycloalkanes and alkylcycloalkanes, aromatic compounds, alkylaromatics.

The hydrocarbon-containing solvent used in the method according to the invention is characterized in that its flash point is above 40° C., preferably above 75° C. and more precisely above 100° C. Its crystallization point is below −5° C.

The solvents of silicone type, alone or in admixture, are for example selected from the group consisting of:

linear polydimethylsiloxanes (PDMS) of (CH₃)₃—SiO—((CH₃)₂—SiO)ₙ—Si(CH₃)₃ type with n ranging between 1 and 900, corresponding to viscosities at ambient temperature ranging between 0.1 and 10,000 mPa·s,

polydiethylsiloxanes having a viscosity at ambient temperature ranging between 0.1 and 10,000 mPa·s,

cyclic polydimethylsiloxanes D₄ to D₁₀, preferably D₅ to D₈. Unit D represents the monomer unit dimethylsiloxane,

poly(trifluoropropyl methyl siloxanes).

The halogenated or perhalogenated solvents used in the method are selected from among perfluorocarbides (PFC), hydrofluoroethers (HFE), perfluoropolyethers (PFPE).

The halogenated or perhalogenated solvent used for implementing the method according to the invention is characterized in that its boiling point is greater than or equal to 70° C. at atmospheric pressure and its viscosity is below 1 Pa·s at ambient temperature and atmospheric pressure.

The proportions of the water/solvent mixture can respectively range between 0.5/99.5 and 60/40 vol. %, preferably between 10/90 and 50/50 vol. %, and more precisely between 20/80 and 40/60 vol. %, and more preferably between 20/80 and 35/65 vol. %, in relation to the total volume of the composition.

The amphiphilic compounds are chemical compounds (monomer or polymer) having at least one hydrophilic or polar chemical group, with a high affinity with the aqueous phase and at least one chemical group having a high affinity with the solvent (commonly referred to as hydrophobic). They have the property of stabilizing the water/non-water-miscible solvent mixture, optionally in emulsion form, and of dispersing the hydrate particles in the non-water-miscible phase.

The amphiphilic compounds comprise a hydrophilic part that can be either neutral or anionic, or cationic, or zwitterionic. The part having a high affinity with the solvent (referred to as hydrophobic) can be hydrocarbon-containing, silicone-containing or fluoro-silicone-containing, or halogenated or perhalogenated.

The hydrocarbon-containing amphiphilic compounds used alone or in admixture are selected from the group consisting of the non-ionic, anionic, cationic or zwitterionic amphiphilic compounds.

The non-ionic compounds are characterized in that they contain:

a hydrophilic part comprising either hydroxy alkylene oxide groups or amino alkylene groups,

a hydrophobic part comprising a hydrocarbon chain derived from an alcohol, a fatty acid, an alkylated derivative of a phenol or a polyolefin, for example derived from isobutene or butene.

The bond between the hydrophilic part and the hydrophobic part can be, for example, an ether, ester or amide function. This bond can also be obtained by a nitrogen or sulfur atom. Examples of non-ionic amphiphilic hydrocarbon-containing compounds are oxyethylated fatty alcohols, alkoxylated alkylphenols, oxyethylated and/or oxypropylated derivatives, sugar ethers, polyol esters, such as glycerol, polyethylene glycol, sorbitol and sorbitan, mono and diethanol amides, carboxylic acid amides, sulfonic acids or amino acids.

The anionic amphiphilic hydrocarbon-containing compounds are characterized in that they contain one or more functional groups ionizable in the aqueous phase so as to form negatively charged ions, these anionic groups providing the surface activity of the molecule. Such a functional group is an acid group ionized by a metal or an amine. The acid can be, for example, carboxylic, sulfonic, sulfuric or phosphoric acid. The following anionic amphiphilic hydrocarbon-containing compounds can be mentioned:

carboxylates such as metallic soaps, alkaline soaps or organic soaps (such as N-acyl amino acids, N-acyl sarcosinates, N-acyl glutamates and N-acyl polypeptides),

sulfonates such as alkylbenzenesulfonates (i.e. alkoxylated alkylbenzenesulfonates), paraffin and olefin sulfonates, ligosulfonates or sulfonsuccinic derivatives (such as sulfosuccinates, hemisulfosuccinates, dialkylsulfosuccinates, for example sodium dioctyl-sulfosuccinate),

sulfates such as alkylsulfates, alkylethersulfates and phosphates.

The cationic amphiphilic hydrocarbon-containing compounds are characterized in that they contain one or more functional groups ionizable in the aqueous phase so as to form positively charged ions. Examples of cationic hydrocarbon-containing compounds are:

alkylamine salts selected from the group consisting of alkylamine ethers, alkyl dimethyl benzyl ammonium derivatives and alkoxylated alkyl amine derivatives,

heterocyclic derivatives such as pyridinium, imidazolium, quinolinium, piperidinium or morpholinium derivatives.

The zwitterionic hydrocarbon-containing compounds are characterized in that they have at least two ionizable groups, such that at least one is positively charged and at least one is negatively charged. The groups are selected from among the anionic and cationic groups described above, such as for example betaines, alkyl amido betaine derivatives, sulfobetaines, phosphobetaines or carboxybetaines.

The amphiphilic compounds comprising a neutral, anionic, cationic or zwifferionic hydrophilic part can also have a silicone or fluoro-silicone hydrophobic part (defined as having a high affinity with the non-water-miscible solvent). These silicone amphiphilic compounds, oligomers or polymers, can also be used for water/organic solvent mixtures, water/halogenated or perhalogenated solvent mixtures or water/silicone solvent mixtures.

The neutral silicone amphiphilic compounds can be oligomers or copolymers of PDMS type wherein the methyl groups are partly replaced by alkylene polyoxide groups (of ethylene polyoxide or propylene polyoxide type or an ethylene polyoxide and propylene mixture polymer) or pyrrolidone groups such as PDMS/hydroxy-alkylene oxypropyl-methyl siloxane derivatives or alkyl methyl siloxane/hydroxy-alkylene oxypropyl-methyl siloxane derivatives.

These copolyols obtained by hydrosilylation reaction have reactive terminal hydroxyl groups. They can therefore be used to obtain ester groups, for example by reaction of a fatty acid, or alkanolamide groups, or glycoside groups.

Silicone polymers comprising alkyl side groups (hydrophobic) directly linked to the silicon atom can also be modified by reaction with fluoro alcohol type molecules (hydrophilic) so as to form amphiphilic compounds.

The surfactant properties are adjusted with the hydrophilic group/hydrophobic group ratio.

PDMS copolymers can also be made amphiphilic by anionic groups such as phosphate, carboxylate, sulfate or sulfosuccinate groups. These polymers are generally obtained by reaction of acids on the terminal hydroxide functions of polysiloxane alkylene polyoxide side chains.

PDMS copolymers can also be made amphiphilic by cationic groups such as quaternary ammonium groups, quaternized alkylamido amine groups, quaternized alkyl alkoxy amine groups or a quaternized imidazoline amine. It is possible to use, for example, the PDMS/benzyl trimethyl ammonium methylsiloxane chloride copolymer or the halogeno N-alkyl-N,Ndimethyl-(3-siloxanylpropyl)ammonium derivatives.

PDMS copolymers can also be made amphiphilic by betaine type groups such as a carboxybetaine, an alkylamido betaine, a phosphobetaine or a sulfobetaine. In this case, the copolymers comprise a hydrophobic siloxane chain and, for example, a hydrophilic organobetaine part of general formula:

(Me₃SiO)(SiMe₂O)ₐ(SiMeRO)SiMe₃

with R═(CH₂)₃+NMe₂(CH₂)_{b}COO⁻; a=0,10; b=1,2.

The amphiphilic compounds comprising a neutral, anionic, cationic or zwitterionic hydrophilic part can also have a halogenated or perhalogenated hydrophobic part (defined as having a high affinity with the non-water-miscible solvent). These halogenated amphiphilic compounds, oligomers or polymers, can also be used for water/organic solvent or water/halogenated or perhalogenated solvent or water/silicone solvent mixtures.

Halogenated amphiphilic compounds such as, for example, fluorine compounds can be ionic or non-ionic. The following can be mentioned in particular:

non-ionic amphiphilic halogenated or perhalogenated compounds such as the compounds of general formula Rf(CH₂)(OC₂H₄)ₙOH, wherein Rf is a partly hydrogenated perfluorocarbon or fluorocarbon chain, where n is an integer at least equal to 1, the fluorinated non-ionic surfactant agents of polyoxyethylene-fluoroalkylether type,

the ionizable amphiphilic compounds for forming anionic compounds, such as perfluorocarboxylic acids and their salts, or perfluorosulfonic acids and their salts, perfluorophosphate compounds, mono and dicarboxylic acids derived from perfluoro polyethers and their salts, mono and disulfonic acids derived from perfluoro polyethers and their salts, perfluoro polyether phosphate amphiphilic compounds and perfluoro polyether diphosphate amphiphilic compounds,

perfluorinated cationic or anionic amphiphilic halogenated compounds or those derived from perfluoro polyethers having 1, 2 or 3 hydrophobic side chains, ethoxylated fluoroalcohols, fluorinated sulfonamides or fluorinated carboxamides.

The amphiphilic compound is added to said water/solvent mixture in a proportion ranging between 0.1 and 10 wt. %, preferably between 0.1 and 5 wt. %, in relation to the phase non-miscible in the aqueous phase, i.e. the solvent.

What is referred to as the “promoter” is, in the sense of the present invention, any chemical compound having the property of lowering the hydrate formation pressure and/or of modifying the hydrate formation kinetics.

The mixture of promoters according to the invention comprises tetrahydrofurane (THF) and at least one promoter of general formula (I):

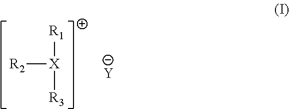

with X═S, N—R₄ or P—R₄,
Y is an anion selected from the group consisting of a hydroxyl, a sulfate or a halogen. The halogen can be selected from the group consisting of bromine, fluorine, chlorine and iodine,
R₁, R₂, R₃, R₄ are identical or different, and selected from the group consisting of linear or branched C1-C5 alkyl radicals. Linear or branched alkyl radicals with 1 to 5 carbon atoms are, in particular, methyl, ethyl, propyl, isopropyl, butyl, isobutyl, sec-butyl, tert-butyl and pentyl radicals.

Among the promoters of formula (I), ammonium alkyls and phosphonium alkyls are preferably used.

Preferably, the promoter of formula (I) is selected from the group consisting of tetraethylammonium bromide (TEAB), tetrapropylammonium bromide (TPAB), tetrabutylammonium hydrogen sulfate (TBAHS), tetrabutylammonium chloride hydrate (TBACI), tetrabutylammonium iodide (TBAI), tetrabutylammonium hydroxide (TBAOH), tetrabutylammonium fluoride hydrate (TBAF), tetrabutylammonium bromide (TBAB), tetrabutylphosphonium bromide (TBPB).

In particular, a subgroup of promoters of formula (II) as follows can be selected:

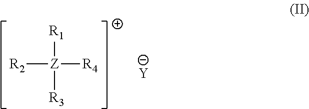

with Z=N or P,
Y is an anion selected from the group consisting of a hydroxyl, a sulfate or a halogen. The halogen can be selected from the group consisting of bromine, fluorine, chlorine and iodine,
R₁═R₂═R₃═R₄=butyl.

Preferably, the promoter of formula (II) can be selected from the group consisting of tetrabutylammonium bromide (TBAB), tetrabutylammonium fluoride hydrate (TBAF) and tetrabutylphosphonium bromide (TBPB).

The tetrahydrofurane promoter can be added to the composition in a proportion ranging between 1 and 15 mole % in relation to the aqueous phase, preferably between 3 and 12 mole % in relation to the aqueous phase and more preferably between 6 and 9 mole % in relation to the aqueous phase.

The promoter of formula (I) can be added to the composition in a proportion ranging between 1 and 20 mass % in relation to the aqueous phase, preferably between 5 and 15 mass % in relation to the aqueous phase and more preferably between 7 and 12 mass % in relation to the aqueous phase.

When the promoter is selected from among the compounds of formula (II), it can be added to the composition in a proportion ranging between 1 and 20 mass % in relation to the aqueous phase, preferably between 5 and 15 mass % in relation to the aqueous phase and more preferably between 7 and 12 mass % in relation to the aqueous phase.

The method of enriching a gaseous effluent in acid gas according to the invention can be applied to different feed gases. For example, the method allows to decarbonate combustion fumes and to deacidize natural gas or a Claus tail gas. The method also allows to remove the acid compounds contained in syngases, in conversion gases, in gases from integrated coal or natural gas combustion plants, in biomass fermentation gases, in cement plant gases and in incinerator fumes. What is referred to as “acid compound” in the sense of the present invention is CO₂ and/or H₂S.

### EXAMPLES

The following examples that illustrate the invention should not be considered as limitative.

Experimental Set-Up and Conditions

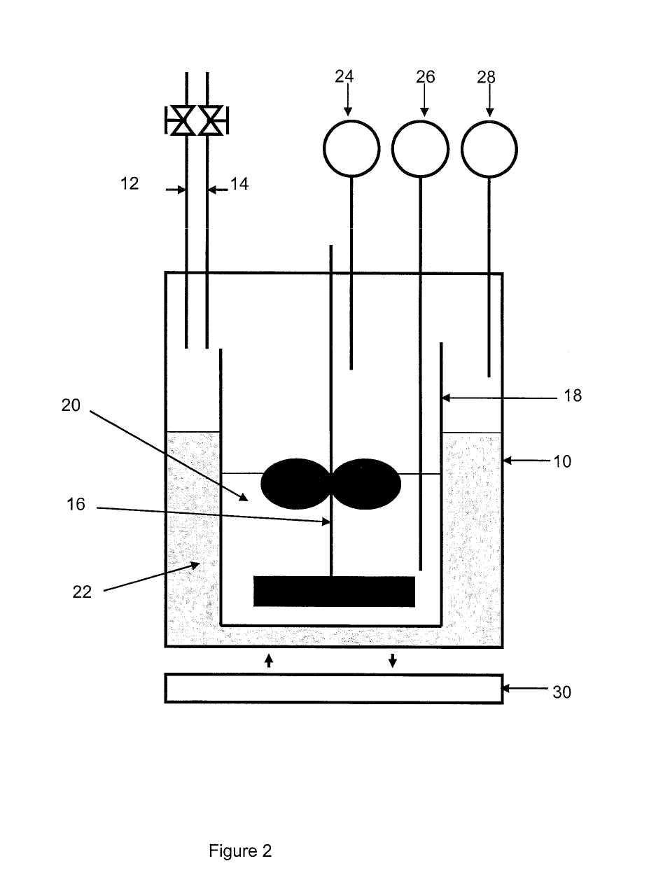

In order to test the efficiency of the composition used in the method according to the invention, we simulate, in the device in connection with FIG. 2, the hydrate formation stage for a gas mixture containing 85 mole % nitrogen and 15 mole % CO₂. The hydrate formation stage is studied in a closed thermostat-controlled reactor wherein the pressure variations of the gas phase and the temperature variations of the gas and liquid phases are measured. These variations are linked with the formation of the hydrates.

In connection with FIG. 2, the device comprises a 3-liter reactor 10 provided with a gas inlet 12 and a gas outlet 14, a stirring device 16 and temperature and pressure detectors 26, 28, 24.

The reactor is filled with a mixture 22 of 270 ml milli-Q water and 2 ml ethylene glycol. A glass tank 18 containing 700 ml of the composition to be tested 20 is placed in the ethylene glycol/water mixture that provides thermal exchange between reactor 10 and tank 18. The temperature of the ethylene glycol/water bath is controlled by a cryostat 30. After closing the reactor, the reactor and the tank are brought to thermal equilibrium at 20° C. after carrying out two successive purges at 10 bars (10 bars=1 MPa) with the gas mixture described above.

The reactor is then fed with the gas mixture described above at the initial operating pressure (5, 15 and 20 bars according to the experiments) and until the set point temperature of 20° C. is reached, Gas supply to the reactor is then stopped. At this stage, the experimental setup is fixed and no other material is added thereafter during the experiment.

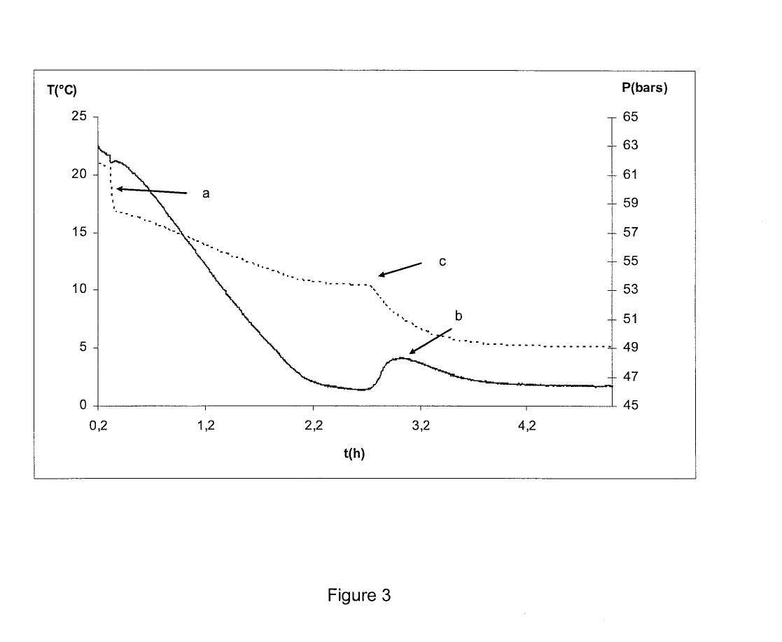

At a predetermined time t, the composition to be tested is stirred at 250 rpm and remains under stirring throughout the experiment. The temperature remains stable at 20° C. for 3 hours, then it decreases at a rate of 0.4° C./min down to −3° C. where it remains stable for 4 hours. The temperature variations of the composition to be tested, as well as the temperature and pressure variations of the gas overhead, are measured by means of detectors 42, 38 and 40 respectively. The temperature (dotted curve) and pressure (full line) variation is plotted on a graph versus time. An example of such a representation is illustrated in FIG. 3. Contact between the gas and the liquid composition to be tested leads to a pressure fall due to the transfer of part of the gas to the composition to be tested (a). This transfer is fast and a new stable state as regards the pressure is obtained within some minutes. An exothermic peak (b) and a pressure drop (c) are then observed; these events correspond to the formation of gas hydrates in the composition to be tested. Modelling the pressure curve as a function of time allows to determine the time constant (K) of the hydrate formation reaction.

No material addition is possible, the experimental setup is thus fixed and the only parameter that can influence hydrate formation is the internal temperature of the reactor. The temperature decrease is controlled by a temperature profile imposed on the thermostat-controlled bath and used as a standard for all the experiments. It can be noted that the temperatures within the reactor evolve much more slowly than that of the thermostat-controlled water/ethylene glycol mixture due to the thermal inertia of the setup, the fluids contained in the reactor and the exothermic and endothermic phenomena created, which explains why the hot and cold plateaus are rather long. At the end of the experiment, the final composition of the gas mixture is analyzed by chromatography.

Base Composition

The compositions to be tested are prepared from a base composition to which one or more promoters are added.

The base composition is made up of ⅓ volume of water and ⅔ volume of solvent to which an amphiphilic compound obtained by reaction between a polyisobutenyl succinic anhydride and polyethylene glycol is added. The amphiphilic compound is added at a concentration of 0.17 wt. % in relation to the volume of solvent. The composition by weight of the solvent is as follows:

for molecules having less than 11 carbon atoms: 20% paraffins and isoparaffins, 48% naphthenes, 10% aromatics;

for molecules having at least 11 carbon atoms: 22% of a mixture of paraffins, isoparaffins, naphthenes and aromatics.

### Example No. 1 (not in Accordance with the Invention)

9 mole % tetrahydrofurane (THF) in relation to the aqueous phase are added to the base composition described above. This composition is tested under the aforementioned experimental conditions for three different initial pressure values: 5, 15 and 20 bars.

The formation of gas hydrates is observed through a pressure drop and the appearance of an exothermic peak when the temperature of the cryostat is decreasing.

The gas consumption kinetics, therefore the gas hydrate formation kinetics can be modelled by means of a model of a first order reaction. With this composition and at a pressure of 20 bars, the time constant (K) of the hydrate formation reaction is 2 hours. At a pressure of 15 bars, the time constant (K) of the hydrate formation reaction is 3 hours and, at 5 bars, it is 4 hours.

The final composition of the gas mixture is 9% CO₂ and 91% N₂.

### Example No. 2 (Not in Accordance with the Invention)

9 mass % TBAB in relation to the aqueous phase are added to the base composition and this composition is tested under the aforementioned experimental conditions for three different initial pressure values: 5, 15 and 20 bars.

No exothermic peak and no pressure decrease is observed.

No hydrate forms under these experimental conditions and in the composition tested.

The final composition of the gas mixture is identical to the composition of the gas mixture that was injected into the reactor: 85% N₂ and 15% CO₂.

### Example No. 3 (in Accordance with the Invention)

A mixture of promoters comprising 9 mole % THF in relation to the aqueous phase and 9 mass % TBAB in relation to the aqueous phase is added to the base composition. This composition is tested under the aforementioned experimental conditions for three different initial pressure values: 5, 15 and 20 bars.

The formation of gas hydrates is observed through the appearance of an exothermic peak and of a pressure decrease.

The gas consumption kinetics, therefore the gas hydrate formation kinetics can be modelled by means of a model of a first order reaction. With this composition and at a pressure of 20 bars, the time constant (K) of the hydrate formation reaction is 1 hour. At a pressure of 15 bars, the time constant (K) of the hydrate formation reaction is 1.84 hours and, at 5 bars, it is 2 hours.

The final composition of the gas mixture is 5% CO₂ and 95% N₂.

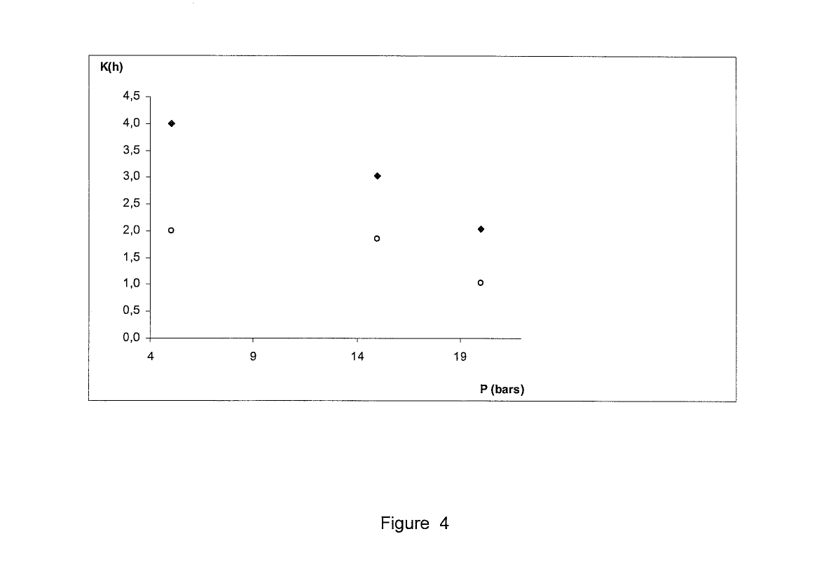

The results of these 3 examples are summarized in FIG. 4 that shows the time constants (K) in hours (ordinate) of the hydrate formation reaction as a function of the initial pressure (in bars, abscissa) for a composition comprising THF (full diamond), a composition comprising TBAB (black triangle) and a composition comprising a mixture of two promoters: THF and TBAB (empty circle). In this figure, it can be seen that, for an initial pressure of 5 and 15 bars, the time constant of the composition comprising the mixture of two promoters (TBAB and THF) is twice as low as that of a composition comprising only THF. The gas hydrates thus form more rapidly in the composition comprising the mixture of two promoters (TBAB and THF) than in the composition comprising only THF as the promoter.

Furthermore, it is observed that there is no gas hydrate formation in a composition comprising a single promoter (black triangle for a composition comprising TBAB) for a pressure of 5, 15 or 20 bars. These pressures are not high enough to allow hydrate formation with this promoter only. Pressures of at least 40 bars would be necessary. Now, when using a composition comprising a mixture of promoters (TBAB and THF, empty circle), hydrate formation is observed from 5 bars.

In conclusion, the composition in accordance with the invention (Example No. 3) allows to:

capture a larger amount of acid compounds than a composition with a single promoter (Examples No. 1 and 2),

significantly increase the hydrate formation reaction kinetics in relation to a composition with a single promoter,

decrease the pressure required for hydrate formation.

These examples show the synergy effect of the two promoters on the hydrate formation kinetics.

1) A method of enriching a gaseous effluent in acid compounds, characterized in that it comprises the following stages:
feeding into a contactor a feed gas comprising acid compounds and a composition comprising:
at least one mixture of two liquid phases non-miscible with one another, including an aqueous phase,
at least one amphiphilic compound,
at least one mixture of promoters comprising tetrahydrofurane and at least one promoter of formula (I) 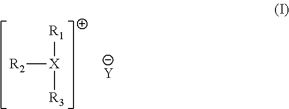
with X═S, N—R₄ or P—R₄,
Y is an anion selected from the group consisting of a hydroxyl, a sulfate or a halogen,
R₁, R₂, R₃, R₄ are identical or different, and selected from the group consisting of linear or branched C1-C5 alkyl radicals,
establishing in said contactor predetermined pressure and temperature conditions for the formation of hydrates consisting of water, promoters and said acid compounds,
carrying said hydrates dispersed in the phase non-miscible in the aqueous phase of said composition through pumping to a hydrate dissociation drum,
establishing in said drum the hydrate dissociation conditions,
discharging the gas resulting from the dissociation, said gas being enriched in acid compounds in relation to the feed gas.

2) A method as claimed in claim 1, wherein the mixture of promoters comprises tetrahydrofurane and at least one promoter of formula (II) 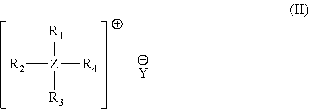
with Z=N or P,
Y is an anion selected from the group consisting of a hydroxyl, a sulfate or a halogen,
R₁═R₂═R₃═R₄=butyl.

3) A method as claimed in claim 1, wherein the promoter of formula (I) is selected from the group consisting of tetraethylammonium bromide (TEAB), tetrapropyl-ammonium bromide (TPAB), tetrabutylammonium hydrogen sulfate (TBAHS), tetrabutylammonium chloride hydrate (TBACI), tetrabutylammonium iodide (TBAI), tetrabutylammonium hydroxide (TBAOH), tetrabutylammonium fluoride hydrate (TBAF), tetrabutylammonium bromide (TBAB), tetrabutylphosphonium bromide (TBPB).

4) A method as claimed in claim 2, wherein the promoter of formula (II) is selected from the group consisting of tetrabutylammonium bromide (TBAB), tetrabutyl-ammonium fluoride hydrate (TBAF) and tetrabutylphosphonium bromide (TBPB).

5) A method as claimed in claim 1, wherein the proportions of the water/solvent mixture respectively range between 0.5/99.5 and 60/40 vol. %, preferably between 10/90 and 50/50 vol. %, and more precisely between 20/80 and 40/60 vol. %.

6) A method as claimed in claim 1, wherein the proportions of the amphiphilic compound range between 0.1 and 10 wt. %, preferably between 0.1 and 5 wt. %, in relation to the phase non-miscible in the aqueous phase.

7) A method as claimed in claim 1, wherein the proportions of the tetrahydrofurane range between 1 and 15 mole % in relation to the aqueous phase.

8) A method as claimed in claim 1, wherein the proportions of the promoter of formula (I) range between 1 and 20 mass % in relation to the aqueous phase.

9) A method as claimed in claim 1, wherein the phase non-miscible in the aqueous phase is selected from the group consisting of hydrocarbon-containing solvents, silicone type solvents, halogenated or perhalogenated solvents, and mixtures thereof.

10) A method as claimed in claim 9, wherein the hydrocarbon-containing solvents are selected from the group consisting of:
aliphatic cuts, notably isoparaffinic cuts,
organic solvents of aromatic cut or naphthenic cut type,
branched alkanes, cycloalkanes and alkylcycloalkanes, aromatic compounds, alkylaromatics,
and wherein the hydrocarbon-containing solvent has a flash point above 40° C., preferably above 75° C. and more precisely above 100° C., and a crystallization point below −5° C.

11) A method as claimed in claim 9, wherein the silicone type solvents, alone or in admixture, are selected from the group consisting of:
linear polydimethylsiloxanes (PDMS) of (CH₃)₃—SiO—[(CH₃)₂—SiO]ₙ—Si(CH₃)₃ type with n ranging between 1 and 900, corresponding to viscosities at ambient temperature ranging between 0.1 and 10,000 mPa·s,
polydiethylsiloxanes in the same viscosity range,
cyclic polydimethylsiloxanes D₄ to D₁₀, preferably D₅ to D₈, unit D representing the monomer unit dimethylsiloxane,
poly(trifluoropropyl methyl siloxanes).

12) A method as claimed in claim 9, wherein the halogenated or perhalogenated solvents are selected from the group consisting of perfluorocarbides (PFC), hydrofluoroethers (HFE), perfluoropolyethers (PFPE), and wherein the halogenated or perhalogenated solvent has a boiling point greater than or equal to 70° C. at atmospheric pressure and a viscosity below 1 Pa·s at ambient temperature and atmospheric pressure.

13) A method as claimed in claim 1, wherein the amphiphilic compound comprises a hydrophilic part and a part having a high affinity with the phase non-miscible in the aqueous phase.

14) A method as claimed in claim 1, wherein said non-ionic amphiphilic compound comprises:
a hydrophilic part comprising hydroxy alkylene oxide groups or amino alkylene groups,
a hydrophobic part comprising a hydrocarbon chain derived from an alcohol, a fatty acid, an alkylated derivative of a phenol or a polyolefin, preferably derived from isobutene or butene.

15) A method as claimed in claim 14, wherein said non-ionic amphiphilic compound is selected from the following group: oxyethylated fatty alcohols, alkoxylated alkylphenols, oxyethylated and/or oxypropylated derivatives, sugar ethers, polyol esters, such as glycerol, polyethylene glycol, sorbitol and sorbitan, mono and diethanol amides, carboxylic acid amides, sulfonic acids or amino acids.

16) A method as claimed in claim 1, wherein said anionic amphiphilic compound is selected from the following group:
carboxylates such as metallic soaps, alkaline soaps or organic soaps, such as N-acyl amino acids, N-acyl sarcosinates, N-acyl glutamates and N-acyl polypeptides,
sulfonates such as alkylbenzenesulfonates, paraffin and olefin sulfonates, ligosulfonates or sulfonsuccinic derivatives, such as sulfosuccinates, hemisulfosuccinates, dialkylsulfosuccinates, for example sodium dioctyl-sulfosuccinate,
sulfates such as alkylsulfates, alkylethersulfates and phosphates.

17) A method as claimed in claim 1, wherein said cationic amphiphilic compound is selected from the following group:
alkylamine salts selected from the group consisting of alkylamine ethers, alkyl dimethyl benzyl ammonium derivatives and alkoxylated alkyl amine derivatives,
heterocyclic derivatives such as pyridinium, imidazolium, quinolinium, piperidinium or morpholinium derivatives.

18) A method as claimed in claim 1, wherein said zwitterionic amphiphilic compound is selected from the following group: betaines, alkyl amido betaine derivatives, sulfobetaines, phosphobetaines, carboxybetaines.

19) A method as claimed in claim 1, wherein said amphiphilic compound comprises a silicone or a fluoro-silicone part.

20) A method as claimed in claim 1, wherein said amphiphilic compound comprises a halogenated or perhalogenated part.

21) A method as claimed in claim 1, wherein the hydrate dispersion pressure is increased by a factor ranging between 2 and 200 times the feed gas pressure.

22) A composition comprising:
at least one mixture of two liquid phases non-miscible with one another, including an aqueous phase,
at least one amphiphilic compound,
at least one mixture of promoters comprising tetrahydrofurane and at least one promoter of formula (I) 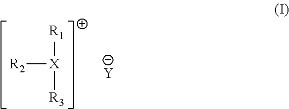
with X═S, N—R₄ or P—R₄,
Y is an anion selected from the group consisting of a hydroxyl, a sulfate or a halogen,
R₁, R₂, R₃, R₄ are identical or different, and selected from the group consisting of linear or branched C1-C5 alkyl radicals.

23) Use of the composition as claimed in claim 22 for gas hydrate formation and/or transport.
